(19) United States
(12) Patent Application Publication
(10) Pub. No.: US 2007/0204473 A1
(43) Pub. Date: Sep. 6, 2007

(54) Spindle locating laser for nut runner

(75) Inventor: Jesse W. Dillon, New Knoxville, OH (US)

Correspondence Address: RANKIN, HILL, PORTER & CLARK LLP, 4080 ERIE STREET, WILLOUGHBY, OH, 44094-7836, US

(73) Assignee: Honda Motor Co., Ltd., Tokyo (JP)

(21) Appl. No.: 11/368,294

(22) Filed: Mar. 3, 2006

(51) Int. Cl. G01C 15/00

(52) U.S. Cl. 33/286

(57) ABSTRACT

An alignment device for aligning a nut runner with a fastener includes a body, a threaded cap, a magnet, and a light source. The magnet and cap are received in one end of the body, while the light source projects from the opposite end of the body. The cap has a fastener-shaped end that is releasably received in the nut runner socket. The light source illuminates a spot that is aligned with the nut runner axis, to permit the user to determine when the nut runner axis is aligned with the fastener to be tightened. Thereafter, the alignment device may be removed from the nut runner socket.

### BACKGROUND OF THE INVENTION

1. Field of the Invention

The present invention is directed toward a device for properly positioning or aligning a tool relative to a fastener to be tightened.

2. Description of Related Art

In modern assembly systems, it is common to tighten fasteners, such as nuts and bolts, with a socket that is driven by spindle. The combination of the spindle and the rotary drive that turns the spindle and, thus the socket, is sometimes referred to as a nut runner.

Prior to using such a nut runner to tighten a fastener, it is necessary to align the nut runner axis of rotation with the fastener to be tightened. While this may seem to be a simple matter, it is sometimes difficult and/or time consuming especially when several fasteners need to be tightened with one or more nut runners. When several fasteners need to be tightened, each fastener may have an associated nut runner, or a single nut runner may be moved between each of the fasteners. In any event, even in automated systems, it is still necessary to align the nut runner rotary axis with a fastener before an automated tightening sequence can be initiated, during periodic calibration, and during a programming sequence.

For example, when setting up a plurality of nut runners to tighten a corresponding plurality of fasteners on a new part, such as an engine head cover, it is necessary to make sure that each nut runner is aligned with the associated fastener. This requires the operator to physically move the nut runner over the part and toward the fastener and, once the nut runner is aligned, to lock the nut runner to prevent lateral (X-Y) movement and thereby just permit the nut runner to move vertically (Z) toward and away from the fastener. This procedure must be repeated for each of the plural nut runner/fastener combinations, and is a burden for the operator. It can be appreciated that, in order to reliably align the nut runner, the operator must be physically very close to the nut runner and the fastener. However, it is undesirable for the user to be positioned within the ‘danger zone’ of an automated machine or robot.

Therefore, there exists a need in the art for an apparatus and method to permit a user to align the nut runner with a fastener while the user is spaced a distance from the fastener so as to be outside a working area of an automated machine or robot that operates the nut runner.

### SUMMARY OF THE INVENTION

The present invention is directed toward an apparatus and method that allows a user to visually align a nut runner axis of rotation with a fastener, while being spaced a distance from the fastener and outside of a working area of an automated machine or robot that operates the nut runner.

More specifically, the present invention includes a tool alignment device that is adapted to fit within a socket of the nut runner. The nut runner includes a rotary drive that drives a spindle. A socket is held at a distal end of the spindle, and is rotated by the spindle to drive a fastener. In according with the present invention, the tool alignment device includes an engagement head that has a shape corresponding to that of a fastener to be driven by the nut runner socket, and thereby is easily positioned within the nut runner socket. An opposite end of the alignment device includes a light source, such as a conventional laser pointer. The laser light beam from the laser pointer is aligned with an axis of the nut runner and, when activated, light projects directly along an extension of the nut runner axis of rotation. When the nut runner rotary axis is in alignment with the fastener, the laser light beam will illuminate a top of a fastener that is to be tightened, thereby clearly indicating to the user that the nut runner is aligned with the fastener without requiring the user to be physically close to the nut runner and fastener.

### BRIEF DESCRIPTION OF THE DRAWINGS

These and further features of the invention will be apparent with reference to the following description and drawings, wherein:

FIG. 1 is a perspective view of the alignment device of the present invention;

FIG. 2 is an exploded perspective view of the alignment device of FIG. 1;

FIG. 3 is an exploded cross-section view of the alignment device;

FIG. 4 is perspective view of a portion of the nut runner and a part with fasteners to be tightened, with the alignment device of the present invention mounted in the nut runner, and the nut runner out of alignment with the fastener to be tightened;

FIG. 5 is similar to FIG. 4, but illustrates the nut runner aligned with the fastener to be tightened.

### DETAILED DESCRIPTION OF THE PREFERRED EMBODIMENTS

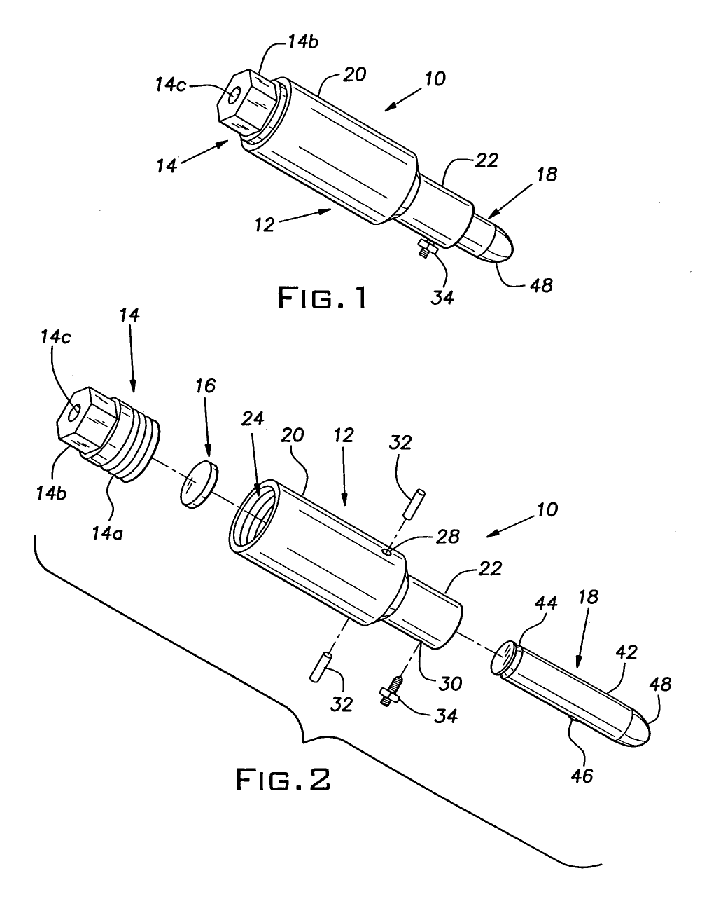

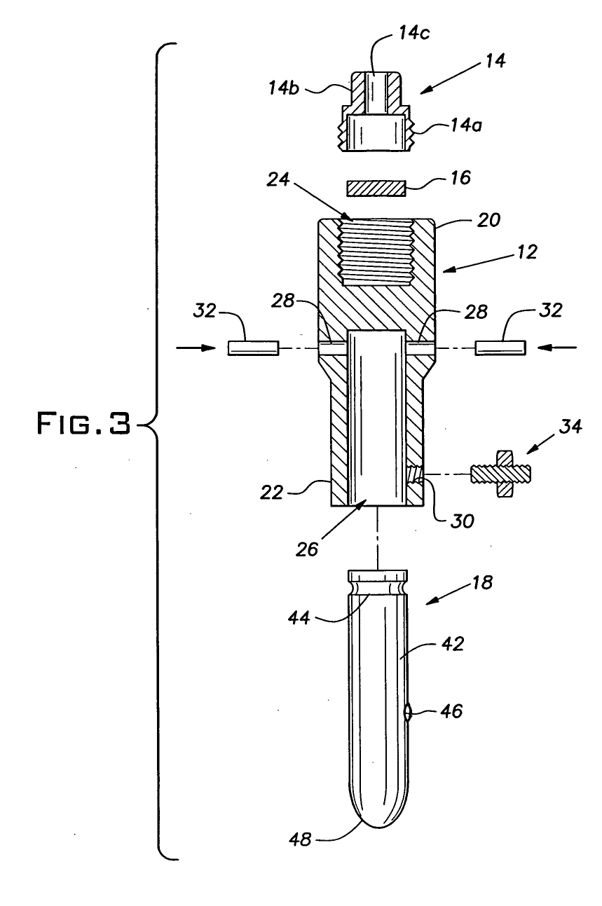

With reference to FIGS. 1-3, the alignment device 10 according to the present invention is shown to include a body 12, a threaded cap 14, a magnet 16, and a light source 18. The body 12 has an enlarged diameter upper end 20 and a reduced diameter lower end 22. The upper end 20 defines a downwardly extending blind bore 24. The magnet 16 is received within the downwardly extending blind bore 24, which is tapped so as to threadingly receive or mate with the threaded cap 14. Preferably, the magnet 16 is a disc-shaped magnet, as illustrated, that is freely received within the downwardly extending blind bore 24.

The reduced diameter lower end 22 of the body 12 also defines an upwardly extending blind bore 26 that is adapted to receive the light source 18. A pair of upper transverse openings 28 and a lower transverse opening 30, are defined in the sidewall of the reduced diameter lower end 22 of the body 12. The upper transverse openings 28 are each adapted to receive a pin 32 that serves to retain the light source 18 within the upwardly extending blind bore 26, whereas the lower transverse opening 30, which preferably is tapped, is adapted to receive a set screw 34. The set screw 34 serves as a switch actuator and permits the light source 18 to be turned on and off.

The threaded cap 14 includes a cylindrical, externally threaded lower portion 14a and an upper fastener-shaped portion 14b. The externally threaded lower portion 14a is threadingly received in the downwardly extending blind bore 24 of the body 12. The upper portion 14b has an exterior shape or profile that is identical to a conventional hex-headed fastener, such as a nut or bolt head, as will be appreciated from the drawings. The upper portion 14b also has a central bore 14c that communicates with the hollow interior of the lower portion 14a and blind bore 24, and serves as a vent to permit air flow into the downwardly extending blind bore 24 and thereby reduce the chance of the magnet 16 being trapped or vapor-locked in any particular position.

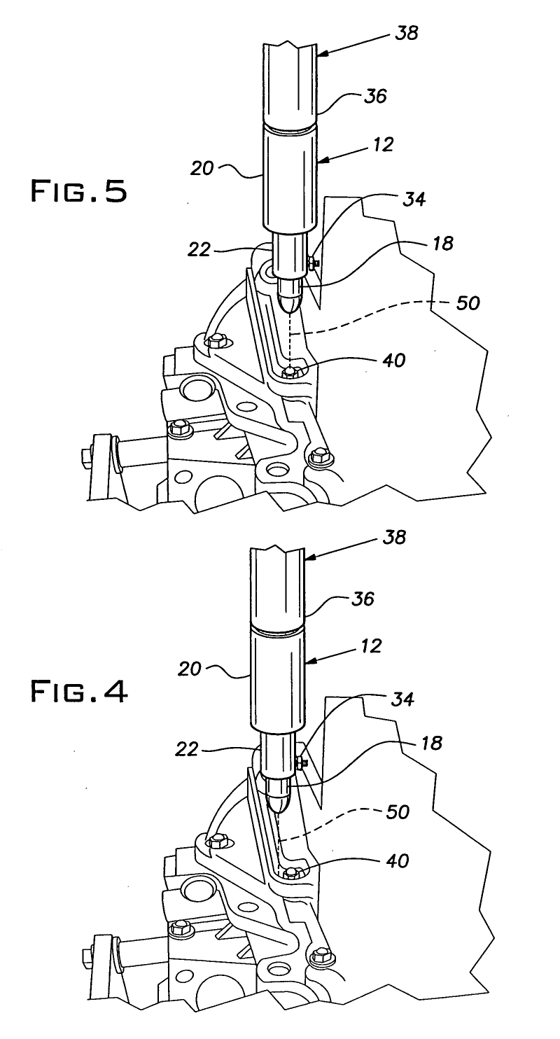

The upper portion 14b is selected and designed to be received in a socket 36 of the nut runner 38, which, in turn, is determined based upon the fastener 40 to be tightened (FIGS. 4-5). In short, the upper portion 14b is selected to match the size and shape of the fastener 40 being tightened. Accordingly, it would be possible to produce a series of different caps 14, and to thread the particular cap 14 that corresponds to the fastener 40 to be tightened, in the body 12 and thereby adapt the alignment device 10 to the particular fastener 40. However, it is believed that it is more likely that a series of complete alignment devices 10, each having a different size hex head cap upper portion 14b corresponding to an associated fastener 40, will be provided to permit more rapid interchangeability of the alignment device 10.

As noted hereinbefore, the magnet 16 is preferably a disc shaped magnet that is sized to fit within the hollow interior of the cap lower portion 14a so as to be disposed adjacent the central bore 14c in the upper portion 14b when in use. The magnet is provided to help releasably secure and retain the alignment device 10 on the nut runner 38 (i.e., in the socket 36), as will be appreciated by those skilled in the art.

The light source 18 is a conventional laser pointer, and defines a somewhat cylinder-shaped body 42 having an upper end with a circumferential groove 44, a slightly projecting on/off switch 46, and a domed distal end 48 from which a laser light beam 50 emanates. When installed within the upwardly extending blind bore 26, the circumferential groove 44 aligns with the upper transverse openings 28 such that the pins 32 may be inserted through the openings 28 and into the groove 44 to retain the laser pointer (light source 18) within the body 12. Similarly, the on/off switch 46 aligns with the lower opening 30 and the set screw 34 retained therein such that rotation of the set screw 34 will actuate the on/off switch 46 to turn the laser pointer on and off. Naturally, it is contemplated that different light source holding and actuating structures may be employed without departing from the scope and spirit of the present invention.

In use, when it is desired to reposition or align the nut runner 38, the alignment device 10 is inserted into the nut runner socket 36. The fastener-shaped end portion 14b is received in the socket 36, and the magnet 16 serves to keep the alignment device 10 from falling out of the socket 36. The on/off switch 46 of the light source 18 is actuated via the set screw 34, and the light beam 50 from the light source is clearly visible to the user. With reference to FIG. 4, the light beam 50 is shown shining on a portion of the part adjacent the fastener 40 to be secured with the nut runner 38. Thereafter, the nut runner 38 is repositioned by watching the light beam 50 and moving the nut runner until the light beam 50 shines directly on the fastener 40. In this condition, as shown in FIG. 5, the axis of rotation of the nut runner is aligned with the fastener 40. Thereafter, the alignment device 10 may be removed from the nut runner socket 36, and the nut runner may be operated in a conventional fashion to tighten the fastener 40.

As described hereinabove, the present invention solves many problems associated with previous type devices. However, it will be appreciated that various changes in the details, materials and arrangements of parts, which have been herein described and illustrated in order to explain the nature of the invention, may be made by those skilled in the art without departing from the principle and scope of the invention, as expressed in the appended claims.

What is claimed is:

1. An alignment device for aligning a nut runner with a fastener to be tightened, said nut runner having a socket that is adapted to fit over the fastener so as to permit said nut runner to rotate the fastener, said alignment device including an engaged portion that is releasably received in the nut runner socket, and a light source connected to said engaged portion and operable to illuminate the fastener when the rotary axis of the nut runner is aligned with said fastener, wherein said engaged portion has a size and shape that is identical to a size and shape of said fastener to be tightened.

2. The tool alignment system of claim 1, wherein the alignment device includes a body and a cap, said body receiving said cap and said light source.

3. The tool alignment system of claim 2, wherein the alignment device further comprises a magnet that is received between said cap and body and is adapted to releasably secure the alignment device to the nut runner socket.

4. The tool alignment system of claim 3, wherein the light source is releasably received in the body.

5. The tool alignment system of claim 4, wherein the light source is a laser pointer.

6. The tool alignment system of claim 5, wherein a set screw extends through said body and is movable to activate a power switch of said laser pointer

7. A method for aligning a tool with a fastener, comprising the steps of:
inserting a tool alignment device into a socket carried by the tool, said socket being rotatably driven about an axis of rotation by a drive source, said tool alignment device including a first end releasably received by said socket and a second end that includes a light source;
actuating the light source such that light is directed towards the fastener; and
visually aligning the tool axis of rotation with the fastener by moving said tool into a position in which the light falls on said fastener.

8. The method according to claim 7, wherein said tool alignment device is magnetically held in said socket.

9. A device for aligning a nut runner with a fastener to be tightened, said device comprising:
a body having an upper end and a lower end;
a threaded cap that is received in the upper end of the body, said cap having an exposed surface that is shaped like the fastener to be tightened and is adapted to be releasably received by a socket of the nut runner;
a magnet that is received in the body upper end and relatively beneath the cap; and,
a light source removably received in said body lower end.

10. The device of claim 9, wherein said body receives a screw that is operable to engage an on/off switch on said light source.

11. The device of claim 9, wherein said light source is a laser pointer.
